(19) United States
(12) Patent Application Publication
(10) Pub. No.: US 2023/0330640 A1
(43) Pub. Date: Oct. 19, 2023

(54) Particulate Filter

(71) Applicant: BASF CORPORATION, Florham Park, NJ (US)

(72) Inventors: Jun Cong JIANG, Shanghai (CN); Ye Hui WU, Shanghai (CN); Florian WALTZ, Hannover (DE); Attilio SIANI, Shanghai (CN); Thomas SCHMITZ, Hannover (DE); Shau Lin CHEN, Shanghai (CN)

(21) Appl. No.: 18/042,649

(22) PCT Filed: Aug. 6, 2021
(86) PCT No.: PCT/US2021/044862

§ 371 Date: Feb. 23, 2023

(30) Foreign Application Priority Data
Aug. 25, 2020 (WO) PCT/CN2020/111092

(51) Int. Cl. B01J 23/78; B01J 23/02; B01J 21/04; B01J 23/34; B01J 35/04; B01J 35/10; B01J 35/02; B01J 35/00; B01D 53/94; F01N 3/28; F01N 3/022; F01N 3/10

(52) U.S. Cl. CPC B01J 23/78; B01J 23/02; B01J 21/04; B01J 23/34; B01J 35/04; B01J 35/1014; B01J 35/026; B01J 35/0026; B01D 53/94; F01N 3/2825; F01N 3/0226; F01N 3/101; F01N 3/106; F01N 3/0222; B01D 2255/2092; B01D 2255/2045; B01D 2255/30; B01D 2255/20707; B01D 2255/2047; B01D 2255/20738; B01D 2255/20715; B01D 2255/9207; B01D 2255/9202; B01D 2255/9155; B01D 2258/012; B01D 2257/702; B01D 2257/502; B01D 2257/404; F01N 2370/04; F01N 2330/06; F01N 2330/32

(57) ABSTRACT

Disclosed herein is a particulate filter for use in an emission treatment system of an internal combustion engine. The particulate filter provides high fresh filtration efficiency and has minimal to no impact on backpressures.

### CROSS-REFERENCE TO RELATED APPLICATIONS

This application claims the benefit of priority to International Application No. PCT/CN2020/111092, filed Aug. 25, 2020 in its entirety.

### DESCRIPTION

### Technical Field

The present invention relates to a particulate filter, in particular a particulate filter for use in an emission treatment system of an internal combustion engine. The particulate filter provides high fresh filtration efficiency; and has minimal to no impact on backpressures.

### Background

The largest portions of most internal combustion exhaust gases contain relatively benign nitrogen (N₂), water vapor (H₂O), and carbon dioxide (CO₂); but the exhaust gas also contains in relatively small part noxious and/or toxic substances, such as carbon monoxide (CO) from incomplete combustion, hydrocarbons (HC) from un-burnt fuel, nitrogen oxides (NOx) from excessive combustion temperatures, and particulate matter (PM).

Certain internal combustion engines, such as lean-burn engines, diesel engines, natural gas engines, power plants, incinerators, or gasoline engines, tend to produce an exhaust gas with a considerable amount of soot and other particulate matter. Particulate matter emissions can be remedied by passing the PM-containing exhaust gas through a particulate filter.

WO2012030533 A1 relates to a method of forming a porous discriminating layer on a ceramic support having at least one porous wall comprising (a) establishing a flow of a gas stream containing particle agglomerates through said at least one porous wall from a gas entry side of said at least one porous wall to a gas outlet side of said at least one porous wall, such that at least a portion of the agglomerates deposit to form a deposited layer of the agglomerates, their constituent particles or both on the gas entry side of said at least one porous wall, wherein (1) at least a portion of the particles that make up the particle agglomerates are of a ceramic material or precursor to a ceramic material, (2) the particles that make up the particle agglomerates have a size from 0.01 to 5 microns (μm), (3) the agglomerates have a size of from 10 to 200 microns and (4) said deposited layer extends only partially through the thickness of said at least one porous wall and (b) calcining said deposited layer to form the discriminating layer.

WO2018115900 A1 relates to a particulate filter for use in an emission treatment system of a gasoline engine, the filter having an inlet side and an outlet side, wherein at least the inlet side is loaded with a synthetic ash.

On Dec. 23, 2016, the Ministry of Environmental Protection (MEP) of the People's Republic of China published the final legislation for the China 6 limits and measurement methods for emissions from light-duty vehicles (GB18352.6—2016; hereafter referred to as China 6), which is much stricter than the China 5 emission standard. Especially, China 6b incorporates limits on particulate matter (PM) and adopts the on-board diagnostic (OBD) requirements. Furthermore, it is implemented that vehicles should be tested under World Harmonized Light-duty Vehicle Test Cycle (WLTC). WLTC includes many steep accelerations and prolonged high-speed requirements, which demand high power output that could have caused “open-loop” situation (as fuel paddle needs to be pushed all the way down) at extended time (e.g., >5 sec) under rich (lambda <1) or under deep rich (lambda <0.8) conditions. Albeit standards become more stringent, it is desirable to provide a further improved particulate filter providing an advantageous combination of higher fresh filtration efficiency and enhanced durability without unduly increasing backpressure so that regulated HC, NOx, and CO conversions can be achieved while meeting particulate matter emissions.

### SUMMARY

The present invention relates to a particulate filter, in particular a particulate filter for use in an emission treatment system of an internal combustion engine.

Aspects include particulate filters for exhaust gas treatment from an internal combustion engine comprising: a filter having an inlet side and an outlet side; and a functional material layer coated onto the inlet side, the outlet side, or both sides of the filter; the functional material layer comprises calcium aluminate.

Other aspects include systems for exhaust gas treatment from an internal combustion engine comprising the particulate filters, and one or more of a selective catalytic reduction (SCR) catalyst, a three way conversion (TWC) catalyst, a diesel oxidation catalyst (DOC), an ammonia oxidation (AMOx) catalyst, a NOx trap, a NOx absorber catalyst, a hydrocarbon trap catalyst.

Other aspects include methods for the treatment of exhaust gas from an internal combustion engine comprising: providing the particulate filter; and flowing the exhaust gas from the engine through the particulate filter.

### BRIEF DESCRIPTION OF DRAWINGS

FIG. 1(a) and FIG. 1(b) show an exemplary wall-flow filter;

FIG. 2 shows a plot of backpressure characteristics of coated particulate filters according to embodiments of the present invention and a comparative particulate filter;

FIG. 3 shows a plot of filtration efficiencies of coated gasoline particulate filters according to embodiments of the present invention and a comparative particulate filter.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

With respect to the terms used in this disclosure, the following definitions are provided.

Throughout the description, including the claims, the term “comprising one” or “comprising a” should be understood as being synonymous with the term “comprising at least one”, unless otherwise specified, and “between” or “to” should be understood as being inclusive of the limits.

The terms “a”, “an” and “the” are used to refer to one or to more than one (i.e., to at least one) of the grammatical object of the article.

The term “and/or” includes the meanings “and”, “or” and also all the other possible combinations of the elements connected to this term.

All percentages and ratios are mentioned by weight unless otherwise indicated.

Thus, according to one aspect of the invention, provided is a particulate filter for exhaust gas treatment from an internal combustion engine comprising:
(1) a filter having an inlet side and an outlet side;
(2) a functional material layer coated onto the inlet side, the outlet side, or both sides of the filter;
   wherein the functional material layer comprises calcium aluminate.

In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. The particulate filter is typically formed of a porous substrate. The porous substrate may comprise a ceramic material such as, for example, cordierite, silicon carbide, silicon nitride, zirconia, mullite, spodumene, alumina-silica-magnesia, zirconium silicate, and/or aluminium titanate, typically cordierite or silicon carbide. The porous substrate may be a porous substrate of the type typically used in emission treatment systems of internal combustion engines.

The internal combustion engine may be a lean-burn engine, a diesel engine, a natural gas engine, a power plant, an incinerator, or a gasoline engine.

The porous substrate may exhibit a conventional honey-comb structure. The filter may take the form of a conventional “flow-through filter”. Alternatively, the filter may take the form of a conventional “wall flow filter” (WFF). Such filters are known in the art.

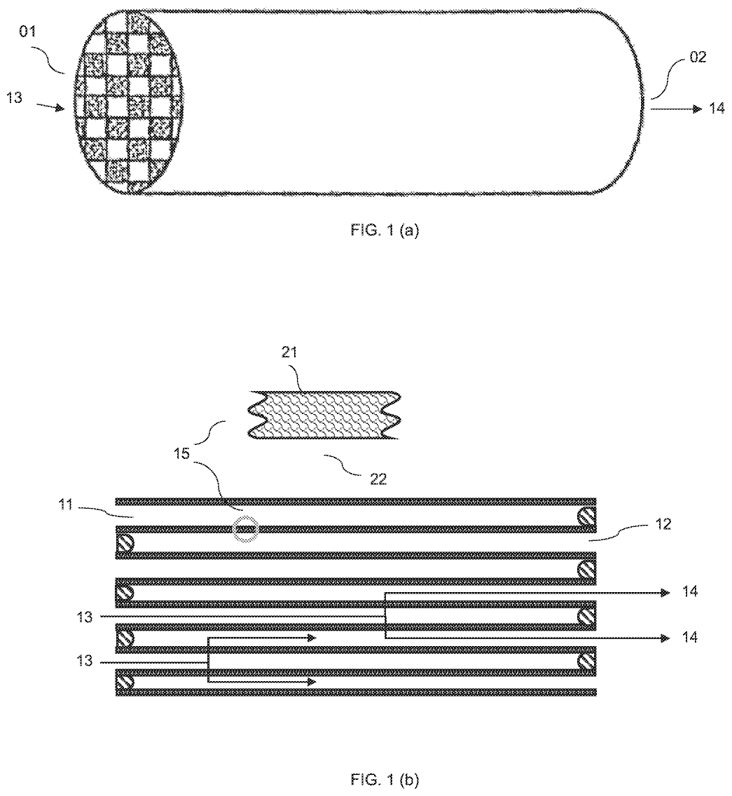

The particulate filter is preferably a wall-flow filter. Referring to FIG. 1(a) and FIG. 1(b), an exemplary wall-flow filter is provided. Wall-flow filters work by forcing a flow of exhaust gases (13) (including particulate matter) to pass through walls formed of a porous material.

A wall flow filter typically has a first face and a second face defining a longitudinal direction therebetween. In use, one of the first face and the second face will be the inlet face for exhaust gases (13) and the other will be the outlet face for the treated exhaust gases (14). A conventional wall flow filter has first and second pluralities of channels extending in the longitudinal direction. The first plurality of channels (11) is open at the inlet face (01) and closed at the outlet face (02). The second plurality of channels (12) is open at the outlet face (02) and closed at the inlet face (01). The channels are preferably parallel to each other to provide a constant wall thickness between the channels. As a result, gases entering one of the plurality of channels from the inlet face cannot leave the monolith without diffusing through the channel walls (15) from the inlet side (21) to the outlet side (22) into the other plurality of channels. The channels are closed with the introduction of a sealant material into the open end of a channel. Preferably the number of channels in the first plurality is equal to the number of channels in the second plurality, and each plurality is evenly distributed throughout the monolith. Preferably, within a plane orthogonal to the longitudinal direction, the wall flow filter has from 100 to 500 channels per square inch, preferably from 200 to 400. For example, on the inlet face (01), the density of open channels and closed channels is from 200 to 400 channels per square inch. The channels can have cross sections that are rectangular, square, circular, oval, triangular, hexagonal, or other polygonal shapes.

In one or more embodiments, the inlet side (21) of the porous walls of the particulate filter is coated with the functional material layer. The functional material layer may be coated on the outlet side (22) of the porous walls of the filter, or both sides (21 and 22). The loading may be characterized as “on wall” loading or “in wall” loading. The former is characterized by the formation of a functional material layer on a surface of the porous walls (15). The latter is characterized by extending partial of the functional material thorough the thickness of the porous walls (15).

In one or more embodiments, the calcium aluminate has a specific surface area of no more than 10 m²/g (BET model, 77K nitrogen adsorption measurement), preferably no more than 5 m²/g, more preferably no more than 1 m²/g, in a fresh state.

In one or more embodiments; the calcium aluminate has a specific surface area of no more than 10 m²/g (BET model, 77K nitrogen adsorption measurement), preferably no more than 5 m²/g, more preferably no more than 1 m²/g, after 4 hr calcination in air at 1000° C.

In one or more embodiments, the calcium aluminate has a D₉₀ of between 6 to 400 μm, preferably between 10 to 200 μm.

In one or more embodiments, the calcium aluminate has a D₅₀ of between 1 to 100 μm, preferably between 1.5 to 50 μm.

In one or more embodiments, the calcium aluminate has a D₁₀ of between 0.1 to 40 μm, preferably between 0.5 to 20 μm.

“D₉₀”, “D₅₀” and “D₁₀” have their usual meaning of referring to the point where the cumulative volume from the small-particle-diameter side reaches 90%, 50% and 10% in the cumulative particle size distribution. D₉₀ is the value determined by measuring the particle size distribution, respectively. The particle size distribution is measured by using laser diffraction particle size distribution analyzer.

In one or more embodiments, the calcium aluminate has a bulk density of 0.2 to 3.0 g/cm₃, preferably 0.3 to 1.8 g/cm³.

“Bulk density”, as used herein, is the mass or weight of material per unit volume, including in the volume considered, the void spaces between the particles.

In one or more embodiments, the mass ratio of aluminum oxide to calcium oxide is preferably 1.5 to 5 in the calcium aluminate.

In one or more embodiments, the calcium aluminate comprises no more than 20% wt, preferably no more than 15% wt, more preferably no more than 10% wt of an inorganic impurity, calculated as its oxide. In some embodiments, the inorganic impurity comprises at least one of silicon, titanium, magnesium, iron, copper, zirconium, cerium, barium.

In one or more embodiments, the functional material layer further comprises a first platinum group metal (PGM) selected from the group consisting of platinum (Pt), palladium (Pd) and rhodium (Rh), and mixtures thereof. The PGM is present in a catalytically effective amount to convert NOx, CO and hydrocarbons in an exhaust gas to N₂, CO₂ and H₂O and to cause the oxidation of particulate matter trapped on the particulate filter.

In one or more embodiments, the functional material layer further comprises one or more of alumina, zirconia, cerin, silica, titania, magnesium oxide, zinc oxide, manganese oxide, iron oxide, silicate zeolite, alumino-silicate zeolite, silicoaluminophosphate (SAPO) zeolite.

In one or more embodiments, the functional material layer further comprises at least one organic material, such as acetic acid, oxalic acid, citric acid, tartaric acid, fumaric acid, lactic acid, malic acid, maleic acid, hexanol, octanol, decanol, cellulose, hydroxylethyl cellulose, methylhydroxylethyl cellulose, starch, polyethylene, polypropylene, polystyrene, poly(oxyethylene), poly(ethylene terephthalate), poly(butylene terephthalate), polyvinyl chloride, polyvinyl alcohol, polyvinylpyrrolidone, polymethyl methacrylate, polyamide, polycarbonates, or polyurethanes.

In one or more embodiments, the functional material may be coated in a particulate form. In preferably embodiments, the functional material is coated in a particulate form via gas phase carrier, i.e. “dry coated” without the use of any liquid carrier. In other embodiments the functional material may be coated in the form of a liquid suspension.

Once coated, the functional material may take the form of a packed bed. For example, when the particulate filter is a wall flow filter, the functional material may form a packed bed against the walls of the plurality of channels open at the inlet side. The packed bed may be formed in the channels open at the inlet side and against the sealant material closing the channels, i.e. towards the outlet end of the inlet channels. The packed bed is typically porous and is typically gas permeable, the pores being sized to trap particulate matter in an internal combustion exhaust, for example soot. The pores of the packed bed are typically smaller than the pores of the porous substrate of the particulate filter. Alternatively, or in addition, the packed bed may be more porous than the walls of the porous substrate (i.e. it may provide a high level of filtration by the provision of a long path length). The packed bed may extend along the walls of the plurality of channels open at the inlet side. The packed bed may take the form of a layer or membrane, for example a continuous layer or membrane. The packed bed may extend along the entire length of the walls of the plurality of channels, or along only part of the length of the walls. Instead of being a packed bed, the functional material may be in the form of a porous coating, e.g. a coating applied as (i.e. derived from) a washcoat slurry. The porous coating may be arranged in a wall flow filter in a similar manner to the packed bed discussed above.

In one or more embodiments, the loading of the functional material layer is between 0.1 and 100 g/L, and preferably between 1 and 75 g/L, and more preferably between 10 and 50 g/L.

In one or more embodiments, the filter further comprises a porous body comprising a plurality of pores, and further comprises a catalytic washcoat within at least a portion of the plurality of pores. The use of the catalytic washcoat may serve to treat components of an internal combustion exhaust gas such as, for example, unburned hydrocarbons, carbon monoxide and/or nitrogen oxide. The catalytic washcoat comprises one or more of a selective catalytic reduction (SCR) catalyst, a diesel oxidation catalyst (DOC), a three-way conversion (TWC) catalyst, an AMOx catalyst, a NOx trap, a NOx absorber catalyst, a hydrocarbon trap catalyst. The catalytic washcoat is typically distributed substantially throughout the plurality of pores. The catalytic washcoat is applied to the particulate filter prior to application of the functional material layer. The catalytic washcoat can be present as a separate coating on the particulate filter or the catalytic washcoat can be integral with the particulate filter, e.g. either the catalytic washcoat can be impregnated as a solution or slurry into the material of a virgin particulate filter, or the catalytic washcoat can be combined with ingredients that form a structure of the substrate monolith that is then extruded into a flow-through monolith and, following drying and calcination, alternate ends of the channels are blocked in a chequer board pattern arrangement at one end of the substrate monolith and unblocked channels are alternately blocked at the opposite end thereof in a similar arrangement. This latter arrangement requires that the porosity of the extrudate following drying and calcination is sufficient to function as a wall-flow filter, i.e. the porosity of the substrate monolith is at least 40%, such as at least 45%, e.g. 50% or at least 55% or up to 75%.

As used herein, the terms of “selective catalytic reduction” and “SCR” refer to the catalytic process of reducing oxides of nitrogen to dinitrogen (N₂) using a nitrogenous reductant. The SCR catalyst may include at least one material selected front: MOR; USY; ZSM-5; ZSM-20; beta-zeolite; CHA; LEV; AEI; AFX; FER; SAPO; ALPO; vanadium; vanadium oxide; titanium oxide; tungsten oxide; molybdenum oxide; cerium oxide; zirconium oxide; niobium oxide; iron; iron oxide; manganese oxide; copper; molybdenum; tungsten; and mixtures thereof. The support structures for the active components of the SCR catalyst may include any suitable zeolite, zeotype, or non-zeolitic compound. Alternatively, the SCR catalyst may include a metal, a metal oxide, or a mixed oxide as the active component. Transition metal loaded zeolites (e.g., copper-chabazite, or Cu-CHA, as well as copper-levyne, or Cu-LEV, as well as Fe-Beta) and zeotypes (e.g., copper-SAPO, or Cu-SAPO) are preferred.

As used herein, the terms of “three-way conversion” and “TWO” refer to a catalytic process that can substantially eliminate HC, CO and NOx from gasoline engine exhaust gases. Typically, a TWC catalyst mainly comprises a platinum group metal (PGM), an oxygen storage component (OSC), and a refractory metal oxide support.

As used herein, the terms of “platinum group meta” and “PGM” refer to one or more chemical elements defined in the Periodic Table of Elements, including platinum, palladium, rhodium, osmium, iridium, and ruthenium, and mixtures thereof.

In some embodiments, the platinum group metal component of the TWC catalyst is selected from platinum, palladium, rhodium, or mixtures thereof. In specific embodiments, the platinum group metal component of the TWC catalyst comprises palladium.

In some embodiments, the TWC catalyst does not comprise an additional platinum group metal (i.e., the TWC comprises only one platinum group metal). In other embodiments, the TWC catalyst comprises an additional platinum group metal. In one or more embodiments, when present, the additional platinum group metal is selected from platinum, rhodium, and mixtures thereof. In specific embodiments, the additional platinum group metal component comprises rhodium, In one or more specific embodiments, the TWC catalyst comprises a mixture of palladium and rhodium. In other embodiments, the TWC catalyst comprises a mixture of platinum, palladium, and rhodium.

As used herein, the terms of “oxygen storage component” and “OSC” refer to an entity that has a multi-valence state and can actively react with reductants such as CO or hydrogen under reduction conditions and then react with oxidants such as oxygen or nitrogen oxides under oxidative conditions. Examples of oxygen storage components include rare earth oxides, particularly ceria, lanthana, praseodymia, neodymia, niobia, europia, samaria, ytterbia, yttria, zirconia, and mixtures thereof in addition to ceria. The rare earth oxide may be in bulk (e.g. particulate) form. The oxygen storage component can include ceria in a form that exhibits oxygen storage properties. The lattice oxygen of ceria can react with carbon monoxide, hydrogen, or hydrocarbons under rich A/F conditions. In one or more embodiments, the oxygen storage component for the TWC catalyst comprises a ceria-zirconia composite or a rare earth- stabilized ceria-zirconia.

As used herein, the terms of “refractory metal oxide support” and “support” refer to underlying high surface area material upon which additional chemical compounds or elements are carried. The support particles have pores larger than 20 A and a wide pore distribution. As defined herein, such supports, e.g., metal oxide supports, exclude molecular sieves, specifically, zeolites. In particular embodiments, high surface area refractory metal oxide supports can be utilized, e.g., alumina support materials, also referred to as “gamma alumina” or “activated alumina,” which typically exhibit a BET surface area in excess of 60 square meters per gram (“m²/g”), often up to about 200 m²/g or higher. Such activated alumina is usually a mixture of the gamma and delta phases of alumina, but may also contain substantial amounts of eta, kappa, and theta alumina phases. Refractory metal oxides other than activated alumina can be used as a support for at least some of the catalytic components in a given catalyst. For example, bulk ceria, zirconia, alpha alumina, silica, titania, and other materials are known for such use.

In some embodiments, the refractory metal oxide supports for the TWC catalyst independently comprise a compound that is activated, stabilized, or both, selected from the group consisting of alumina, zirconia, alumina-zirconia, lanthana-alumina, lanthana-zirconia-alumina, alumina-chromia, ceria, alumina-ceria, and combinations thereof.

As used herein, the terms of “diesel oxidation catalyst” and “DOC” refer to diesel oxidation catalysts, which are well-known in the art. Diesel oxidation catalysts are designed to oxidize CO to CO₂ and gas phase HC and an organic fraction of diesel particulates (soluble organic fraction) to CO₂ and H₂O. Typical diesel oxidation catalysts include platinum and optionally also palladium on a high surface area inorganic oxide support, such as alumina, silica-alumina, titania, silica-titania, and a zeolite. As used herein, the term includes a DEC (Diesel Exotherm Catalyst) with creates an exotherm.

As used herein, the terms of “ammonia oxidation catalyst” and “AMOx” refer to catalysts comprise at least a supported precious metal component, such as one or more platinum group metals (PGMs), which is effective to remove ammonia from an exhaust gas stream. In specific embodiments, the precious metal may include platinum, palladium, rhodium, ruthenium, iridium, silver or gold. In specific embodiments, the precious metal component includes physical mixtures or chemical or atomically-doped combinations of precious metals.

The precious metal component is typically deposited on a high surface area refractory met-al oxide support. Examples of suitable high surface area Refractory Metal Oxides include alumina, silica, titania, ceria, and zirconia, magnesia, barium oxide, manganese oxide, tungsten oxide, and rear earth metal oxide rear earth metal oxide, base metal oxides, as well as physical mixtures, chemical combinations and/or atomically-doped combinations there-of.

As used herein, the terms of “NOx adsorbed catalyst” and “NOx trap (also called Lean NOx trap, abbr. LNT)” refer to catalysts for reducing oxides of nitrogen (NO and NO₂) emissions from a lean burn internal combustion engine by means of adsorption. Typical NOx trap includes alkaline earth metal oxides, such as oxides of Mg, Ca, Sr and Ba, alkali metal oxides such as oxides of Li, Na, K, Rb and Cs, and rare earth metal oxides such as oxides of Ce, La, Pr and Nd in combination with precious metal catalysts such as platinum dispersed on an alumina support have been used in the purification of exhaust gas from an internal combustion engine. For NOx storage, baric is usually preferred because it forms nitrates at lean engine operation and releases the nitrates relatively easily under rich conditions.

As used herein, the term of “hydrocarbon trap” refers to catalysts for trapping hydrocarbons during cold operation periods and releasing them for oxidation during higher-temperature operating periods. The hydrocarbon trap may be provided by one or more hydrocarbon (HC) storage components for the adsorption of various hydrocarbons (HC). Typically, hydrocarbon storage material having minimum interactions of precious metals and the material can be used, e.g., a micro-porous material such as a zeolite or zeolite-like material. Preferably, the hydrocarbon storage material is a zeolite. Beta zeolite is particularly preferable since large pore opening of beta zeolite allows hydrocarbon molecules of dies& derived species to be trapped effectively. Other zeolites such as faujasite, chabazite, clinoptilolite, mordenite, silicalite, zeolite X, zeolite Y, ultrastable zeolite Y, ZSM-5 zeolite, offretite, can be used in addition to the beta zeolite to enhance HC storage in the cold start operation.

Other aspects include systems for exhaust gas treatment from an internal combustion engine comprising the particulate filters, and one or more of a selective catalytic reduction (SCR) catalyst, a three way conversion (TWC) catalyst, a diesel oxidation catalyst (DOC), an ammonia oxidation (AMOx) catalyst, a NOx trap, a NOx absorber catalyst, a hydrocarbon trap catalyst.

Other aspects include methods for the treatment of exhaust gas from an internal combustion engine comprising: providing the particulate filter; and flowing the exhaust gas from the engine through the particulate filter. Typically, the exhaust gas comprises unburnt hydrocarbons, carbon monoxide, nitrogen oxides, and particulate matter.

In one or more embodiments, the particulate filter is canned. in an alternative embodiment, the filter is uncanned. Being “canned” means that the particulate filter has been incorporated into a housing for incorporation into an emission treatment system.

Being “uncanned” means that the particulate filter has not yet been incorporated into a housing for incorporation into an emission treatment system but is still coated with the functional material layer. In a typical canning process, the particulate filter is sleeved in a support mat, typically formed of ceramic fibers or alumina fibers, before being incorporated into a metal housing. Methods of incorporating the particulate filter into a metal housing include, for example, “clam-shell”, “stuffing and “tourniquet” techniques. Such techniques are known in the art.

Filter durability includes hydrothermal stability and the tolerance against extreme environments such as condensate water caused by low temperature in winter. Water exposure remains one of the most significant factors impacting the performance of the particulate filter. It is surprisingly found that when incorporated into an emission treatment system of an internal combustion engine, the particulate filter exhibits a high fresh filtration efficiency, especially after exposure to water.

### EMBODIMENTS The following embodiments serve to further illustrate the invention as disclosed herein, and are not to be construed as limiting thereof.

1. A particulate filter for exhaust gas treatment from an internal combustion engine comprising:
   (1) a filter having an inlet side and an outlet side;
   (2) a functional material layer coated onto the inlet side, the outlet side, or both sides of the filter;
      wherein the functional material layer comprises calcium aluminate.
2. The particulate filter according to embodiment 1, wherein the calcium aluminate has a specific surface area of no more than 10 m²/g, in a fresh state.
3. The particulate filter according to embodiment 1 or 2, wherein the calcium aluminate has a specific surface area of no more than 10 m²/g, after 4 hr calcination in air at 1000° C.
4. The particulate filter according to any one of embodiments 1 to 3, wherein the calcium aluminate has a D₉₀ of 6 to 400 μm, preferably 10 to 200 μm.
5. The particulate filter according to any one of embodiments 1 to 4, wherein the calcium aluminate has a bulk density of 0.2 to 3.0 g/cm³, preferably 0.3 to 1.8 g/cm³.
6. The particulate filter according to any one of embodiments 1 to 5, wherein the mass ratio of aluminum oxide to calcium oxide is 1.1 to 9, preferably 1.5 to 5 in the calcium aluminate.
7. The particulate filter according to any one of embodiments 1 to 6, wherein the calcium aluminate comprises no more than 20% wt, preferably no more than 15% wt, more preferably no more than 10% wt of an inorganic impurity, calculated as its oxide.
8. The particulate filter according to embodiment 7, wherein the inorganic impurity comprises at least one of silicon, titanium, magnesium, iron, copper, zirconium, cerium, barium.
9. The particulate filter according to any one of embodiments 1 to 8, wherein the functional material layer is coated in a particulate form, preferably coated in a particulate form via gas phase carrier.
10. The particulate filter according to any one of embodiments 1 to 9, wherein the loading of the functional material layer is between 0.1 and 100 g/L, and preferably between 1 and 75 g/L, and more preferably between 10 and 50 g/L.
11. The particulate filter according to any one of embodiments 1 to 10, wherein the filter further comprises a porous body comprising a plurality of pores, and a catalytic washcoat within at least a portion of the plurality of pores; wherein the catalytic washcoat comprises one or more of a selective catalytic reduction (SCR) catalyst, a diesel oxidation catalyst (DOC), a three-way conversion (TWC) catalyst, an AMOx catalyst, a NOx trap, a NOx absorber catalyst, a hydrocarbon trap catalyst;
   wherein the catalytic washcoats are applied to the particulate filter prior to application of the functional material layer.
12. A system for exhaust gas treatment from an internal combustion engine comprising: the particulate filter according to any one of embodiments 1 to 11, and one or more of a selective catalytic reduction (SCR) catalyst, a three way conversion (TWC) catalyst, a diesel oxidation catalyst (DOC), an ammonia oxidation (AMOx) catalyst, a NOx trap, a NOx absorber catalyst, a hydrocarbon trap catalyst.
13. A method for the treatment of exhaust gas from an internal combustion engine comprising:
   (1) providing the particulate filter according to any one of embodiments 1-11, and
   (2) conducting the exhaust gas from the engine through the particulate filter.
14. The method according to embodiment 13, wherein the exhaust gas comprises unburnt hydrocarbons, carbon monoxide, nitrogen oxides, and particulate matter.

### EXAMPLES

The present invention is more fully illustrated by the following examples, which are set forth to illustrate the present invention and is not to be construed as limiting thereof. Unless otherwise noted, all parts and percentages are by weight, and all weight percentages are expressed on a dry basis, meaning excluding water content, unless otherwise indicated. In each of the examples, the carrier was cordierite.

### Example 1—Comparative

A gasoline particulate filter having a catalytic layer was prepared using a single coat from inlet side of a filter substrate purchased from Corning®. The filter substrate had a size of 143.8 mm (D)*152.4 mm (L), a volume of 2.47 L, a cell density of 300 cells per square inch, a wall thickness of approximately 200 μm, a porosity of 65% and a mean pore size of 18 pm in diameter by mercury intrusion measurements.

The catalytic layer onto the substrate contains a prior art three-way conversion (TWC) catalyst composite containing palladium and rhodium with a total precious metal loading of 7 g/ft³ and with a Pt/Pd/Rh ratio of 0/2/5. The coat was prepared as following:

The component applied from inlet side was a high surface area gamma alumina, a ceria-zirconia composite with 40% ceria by weight as oxygen storage component, palladium, rhodium, barium oxide and zirconia oxide, at concentrations of approximately 24.8 wt. %, 68.7 wt. %, 0.1 wt. %, 0.2 wt. %, 5.0 wt. % & 1.3 wt. %, respectively, based on the calcined weight of the catalyst. The barium oxide was introduced as a hydroxide solution. The zirconium oxide was introduced as a nitrate solution. The total loading of the coat was 1.23 g/in³.

Rhodium in the form of a rhodium nitrate solution was impregnated by planetary mixer (P-mixer) onto the high surface area gamma alumina and the ceria zirconia composite to form a wet powder while achieving incipient wetness. Palladium in the form of a palladium nitrate solution was impregnated by planetary mixer (P-mixer) onto the high surface area gamma alumina and the ceria zirconia composite to form a wet powder while achieving incipient wetness. An aqueous slurry was formed. The barium solution and the zirconium solution were added. The slurry was milled to a particle size of 90% being 5 microns. The slurry was then coated onto the inlet side of the wall flow cordierite filter using deposition methods known in the art. After coating, the filter plus the inlet coat were dried and then calcined at a temperature of 550° C. for about 1 hour. The resulted catalyzed gasoline particulate filter is used as comparative example.

### Example 2—Comparative

A catalyzed gasoline particulate filter according to Example 1, onto which a functional layer was applied into the inlet side of the filter.

The functional material layer applied was a high surface area gamma alumina. The alumina was dry milled to a particle size of 90% being 5 microns, 50% being 2.5 microns, and 10% being 1 micron, of which the specific surface area (BET model, 77 K nitrogen adsorption measurement) is 147 m²·g⁻¹ at fresh state and 70 m²·g⁻¹ after 4 hr calcination in air at 1000° C. The high surface area gamma alumina, in powder form, was mixed with gas carrier and blown-in into the part at room temperature. The flow rate of gas carrier is 750 kg/hr. The loading of the functional material layer was 0.049 g/in³.

After coating, the filter plus the inlet functional material layer were dried and then calcined at a temperature of 450° C. for about 30 minutes.

### Example 3—Comparative

A catalyzed gasoline particulate filter according to Example 1, onto which a functional layer was applied into the inlet side of the filter.

The functional material layer applied was a high surface area 5 wt. % silica doped gamma alumina. The alumina was dry milled to a particle size of 90% being 5.5 microns, 50% being 2.4 microns, and 10% being 0.9 micron, of which the specific surface area (BET model, 77 K nitrogen adsorption measurement) is 155 m²·g¹ at fresh state and 95 m²·g¹ after 4 hr calcination in air at 1000° C. The high surface area gamma alumina, in powder form, was mixed with gas carrier and blown-in into the part at room temperature. The flow rate of gas carrier is 750 kg/hr. The loading of the functional material layer was 0.049 g/in³.

After coating, the filter plus the inlet functional material layer were dried and then calcined at a temperature of 450° C. for about 30 minutes.

### Example 4—Comparative

A catalyzed gasoline particulate filter according to Example 1, onto which a functional layer was applied into the inlet side of the filter.

The functional material layer applied was a high surface area 5 wt. % silica doped gamma alumina. The alumina was dry milled to a particle size of 90% being 5.5 microns, 50% being 2.4 microns, and 10% being 0.9 micron, of which the specific surface area (BET model, 77 K nitrogen adsorption measurement) is 155 m²·g⁻¹ at fresh state and 95 m²·g⁻¹ after 4 hr calcination in air at 1000° C. The high surface area gamma alumina, in powder form, was mixed with gas carrier and blown-in into the part at room temperature. The flow rate of gas carrier is 750 kg/hr. The loading of the functional material layer was 0.245 g/in³.

After coating, the filter plus the inlet functional material layer were dried and then calcined at a temperature of 450° C. for about 30 minutes.

### Example 5—Comparative

A gasoline particulate filter according to Example 1, onto which a functional layer was applied into the inlet side of the filter.

The functional material layer applied was a mixture of a high surface area gamma alumina and a calcium oxide. The mixture was made with 63 wt. % alumina and 37 wt. % calcium oxide, respectively. The alumina in the mixture was dry milled to a particle size of 90% being 5 microns, 50% being 2.5 microns, and 10% being 1 micron, of which the specific surface area (BET model, 77 K nitrogen adsorption measurement) is 147 m²·g⁻¹ at fresh state and 70 m²g⁻¹ after 4 hr calcination in air at 1000° C. And the calcium oxide in the mixture was dry milled to a particle size of 90% being 90 microns, 50% being 32 microns, and 10% being 1.5 micron, of which the specific surface area (BET model, 77 K nitrogen adsorption measurement) is <1 m²·g⁻¹ both at fresh state and after 4 hr calcination in air at 1000° C. The mixture material, in powder form, was mixed with gas carrier and blown-in into the part at room temperature. The flow rate of gas carrier is 750 kg/hr. The loading of the functional material layer was 0.294 g/in³.

After coating, the filter plus the inlet functional material layer was treated under high humidity conditions, dried and then calcined at a temperature of 450° C. for about 30 minutes.

### Example 6

A gasoline particulate filter according to Example 1, onto which a functional layer was applied into the inlet side of the filter.

The functional material layer applied was a calcium aluminate composite material, with 56 wt. % alumina, 33 wt. % calcium oxide, 5.0 wt. % silica, 3.0 wt. % titania, 1.7 wt. % magnesium oxide and 1.4 wt. % iron oxide. This calcium aluminate composite material was dry milled to a particle size of 90% being 103 microns, 50% being 28 microns, and 10% being 3.0 micron, of which the specific surface area (BET model, 77 K nitrogen adsorption measurement) is <1 m²·g⁻¹ both at fresh state and after 4 hr calcination in air at 1000° C. The calcium aluminate composite material, in powder form, was mixed with gas carrier and blown-in into the part at room temperature. The flow rate of gas carrier is 750 kg/hr. The loading of the functional material layer was 0.245 g/in³.

After coating, the filter plus the inlet functional material layer was treated under high humidity conditions, dried and then calcined at a temperature of 450° C. for about 30 minutes.

### Example 7

A gasoline particulate filter according to Example 1, onto which a functional layer was applied into the inlet side of the filter.

The functional material layer applied was a mixture of a high surface area gamma alumina and a calcium aluminate composite material. The mixture was made with 16.7 wt. % alumina and 83.3 wt. % calcium aluminate composite material, respectively. The calcium aluminate composite material is composing of 56 wt. % alumina, 33 wt. % calcium oxide, 5.0 wt. % silica, 3.0 wt. % titania, 1.7 wt. % magnesium oxide and 1.4 wt. % iron oxide. The alumina in the mixture was dry milled to a particle size of 90% being 5 microns, 50% being 2.5 microns, and 10% being 1 micron, of which the specific surface area (BET model, 77 K nitrogen adsorption measurement) is 147 m²·g⁻¹ at fresh state and 70 m²·g⁻¹ after 4 hr calcination in air at 1000° C. And the calcium aluminate composite material was dry milled to a particle size of 90% being 103 microns, 50% being 28 microns, and 10% being 3.0 micron, of which the specific surface area (BET model, 77 K nitrogen adsorption measurement) is <1 m²·g⁻¹ both at fresh state and after 4 hr calcination in air at 1000° C. The mixture material, in powder form, was mixed with gas carrier and blown-in into the part at room temperature. The flow rate of gas carrier is 750 kg/hr. The loading of the functional material layer was 0.294 g/in³.

### Example 8

A gasoline particulate filter according to Example 6, onto which a second functional layer was applied to the outlet side of the filter.

This second functional material layer applied to the outlet side of the filter was a calcium aluminate composite material, with 56 wt. % alumina, 33 wt. % calcium oxide, 5.0 wt. % silica, 3.0 wt. % titania, 1.7 wt. % magnesium oxide and 1.4 wt. % iron oxide. This calcium aluminate composite material was dry milled to a particle size of 90% being 103 microns, 50% being 28 microns, and 10% being 3.0 micron, of which the specific surface area (BET model, 77 K nitrogen adsorption measurement) is <1 m²·g⁻¹ both at fresh state and after 4 hr calcination in air at 1000° C. The calcium aluminate composite material, in powder form, was mixed with gas carrier and blown-in into the part at room temperature. The flow rate of gas carrier is 750 kg/hr. The loading of the second functional material layer was 0.245 g/in³. The total loading of combined first and second functional material layers was 0.49 g/in³.

After coating, the filter plus the outlet functional material layer was treated under high humidity conditions, dried and then calcined at a temperature of 450° C. for about 30 minutes.

### Example 9

A gasoline particulate filter according to Example 1, onto which a functional layer was applied into the inlet side of the filter.

The functional material layer applied was a calcium alum ate composite material, with 56 wt. % alumina, 33 wt. % calcium oxide, 5.0 wt. % silica, 3.0 wt. % titania, 1.7 wt. % magnesium oxide and 1.4 wt. % iron oxide. This calcium aluminate composite material was dry milled to a particle size of 90% being 35 microns, 50% being 3.4 microns, and 10% being 0.87 micron, of which the specific surface area (BET model, 77 K nitrogen adsorption measurement) is <1 m²·g⁻¹ both at fresh state and after 4 hr calcination in air at 1000° C. The calcium aluminate composite material, in powder form, was mixed with gas carrier and blown-in into the part at room temperature. The flow rate of gas carrier is 750 kg/hr. The loading of the functional material layer was 0.245 g/in³.

After coating, the filter plus the inlet functional material layer was treated under high humidity conditions, dried and then calcined at a temperature of 450° C. for about 30 minutes.

### Example 10

A gasoline particulate filter according to Example 1, onto which a functional layer was applied into the inlet side of the filter.

The functional material layer applied was a calcium aluminate composite material, with 81 wt. % alumina, 17 wt. % calcium oxide, 0.7 wt. % silica, 0.6 wt. % magnesium oxide and 0.7 wt. % zirconia. This calcium aluminate composite material was dry milled to a particle size of 90% being 29 microns, 50% being 8.8 microns, and 10% being 2.0 micron, of which the specific surface area (BET model, 77 K nitrogen adsorption measurement) is <1 m²·g⁻¹ both at fresh state and after 4 hr calcination in air at 1000° C. The calcium aluminate composite material, in powder form, was mixed with gas carrier and blown-in into the part at room temperature. The flow rate of gas carrier is 750 kg/hr. The loading of the functional material layer was 0.245 g/in³.

After coating, the filter plus the inlet functional material layer was treated under high humidity conditions, dried and then calcined at a temperature of 450° C. for about 30 minutes.

Example 11

A gasoline particulate filter according to Example 1, onto which a functional layer was applied into the inlet side of the filter.

The functional material layer applied was a mixture of a calcium aluminate composite material and a high surface area gamma alumina. The mixture was made with 83 wt. % calcium aluminate composite and 17% wt. % high surface area gamma alumina, respectively. The calcium aluminate composite material is consisting of 81 wt. % alumina, 17 wt. % calcium oxide, 0.7 wt. % silica, 0.6 wt. % magnesium oxide and 0.7 wt. % zirconia. This calcium aluminate composite material was dry milled to a particle size of 90% being 29 microns, 50% being 8.8 microns, and 10% being 2.0 micron, of which the specific surface area (BET model, 77 K nitrogen adsorption measurement) is <1 m²·g⁻¹ both at fresh state and after 4 hr calcination in air at 1000° C. The high surface area gamma alumina was dry milled to a particle size of 90% being 5 microns, 50% being 2.5 microns, and 10% being 1 micron, of which the specific surface area (BET model, 77 K nitrogen adsorption measurement) is 147 m²·g⁻¹ at fresh state and 70 m²·g⁻¹ after 4 hr calcination in air at 1000° C. The mixture material, in powder form, was mixed with gas carrier and blown-in into the part at room temperature. The flow rate of gas carrier is 750 kg/hr. The loading of the functional material layer was 0.294 g/in³.

After coating, the filter plus the inlet functional material layer was treated under high humidity conditions, dried and then calcined at a temperature of 450° C. for about 30 minutes.

### Example 12

A gasoline particulate filter according to Example 1, onto which a functional layer was applied into the inlet side of the filter.

The functional material layer applied was a mixture of a calcium aluminate composite material and a high surface area manganese oxide doped gamma alumina. The mixture was made with 83 wt. % calcium aluminate composite and 17% wt. % high surface area manganese oxide doped gamma alumina, respectively. The calcium aluminate composite material is consisting of 81 wt. % alumina, 17 wt. % calcium oxide, 0.7 wt. % silica, 0.6 wt. % magnesium oxide and 0.7 wt. % zirconia. This calcium aluminate composite material was dry milled to a particle size of 90% being 29 microns, 50% being 8.8 microns, and 10% being 2.0 micron, of which the specific surface area (BET model, 77 K nitrogen adsorption measurement) is <1 m²·g⁻¹ both at fresh state and after 4 hr calcination in air at 1000° C. The high surface area manganese oxide doped gamma alumina is consisting of 50 wt. % gamma alumina, 50 wt. % manganese oxide. This manganese doped alumina material was dry milled to a particle size of 90% being 8 microns, 50% being 2.8 microns, and 10% being 1.2 micron, of which the specific surface area (BET model, 77 K nitrogen adsorption measurement) is 121 m²·g⁻¹ at fresh state and 52 m²·g⁻¹ after 4 hr calcination in air at 1000° C. The mixture material, in powder form, was mixed with gas carrier and blown-in into the part at room temperature. The flow rate of gas carrier is 750 kg/hr. The loading of the functional material layer was 0.294 g/in³. After coating, the filter plus the inlet functional material layer was treated under high humidity conditions, dried and then calcined at a temperature of 450° C. for about 30 minutes.

### Example 13—Water Treatment

Water treatment of the above coated gasoline particulate filter examples (Examples 1 to 12) was conducted as following: the filter was lain on its side and immersed in water for 1 hour, during which time the depth of the water was kept between 40-50 mm. Then the filter part was turned upright with inlet side on top to drain the excessive amount of water absorbed, dried by forced hot air flow (180° C. inlet temperature and 50 kg/hr flow rate) through the filter from inlet side to outlet side, and calcined at a temperature of 450° C. for about 30 minutes.

### Example 14—Testing

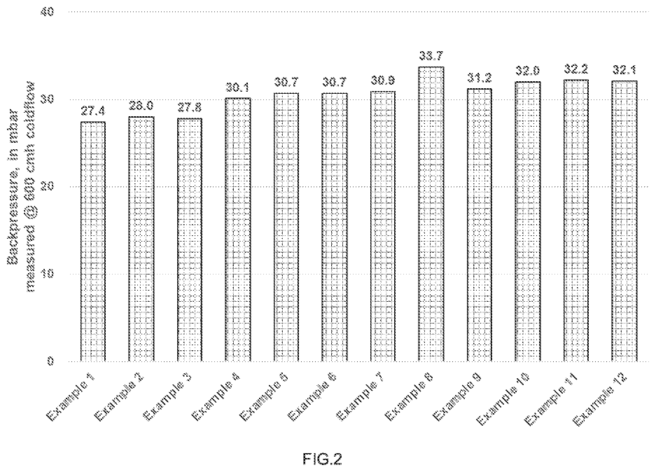

Backpressure characteristics of the above coated gasoline particulate filter examples (Examples 1 to 12) were investigated under cold air flow at 600 cubic meter per hour (cmh). The results are shown in FIG. 2. Filters applied with the functional material layer (Examples 2 to 12), after water treatment, exhibited no big difference or slight increase in backpressure compared to the prior-art catalyzed gasoline particulate filter (Example 1).

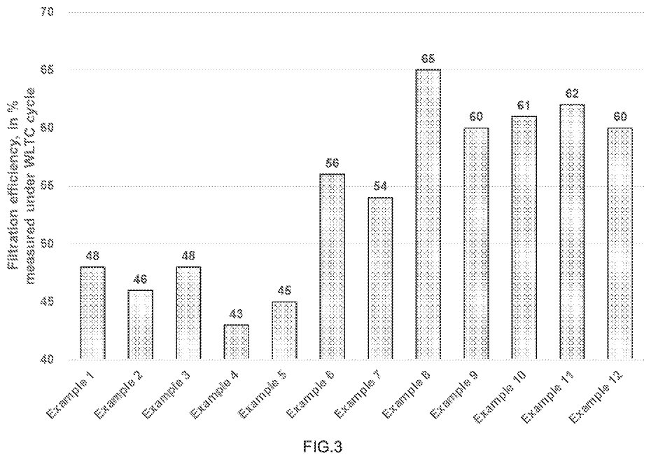

The filtration efficiencies of the above coated gasoline particulate filter examples at fresh state (0 km, or out-of-box state) were measured in the first close-coupled position (SGE 1.5 L turbo gasoline direct injection engine; WLTC testing; PN engine out=4.0×10¹² #/km), and the results are shown in FIG. 3. Noticeably, after water treatment, only examples with calcium aluminate as functional material (Examples 6 to 12) showed higher filtration efficiency increase compared to the prior-art catalyzed gasoline particulate filter (Example 1).

1. A particulate filter for exhaust gas treatment from an internal combustion engine comprising:
(1) a filter having an inlet side and an outlet side; and
(2) a functional material layer coated onto the inlet side, the outlet side, or both sides of the filter;
wherein the functional material layer comprises calcium aluminate.

2. The particulate filter according to claim 1, wherein the calcium aluminate has a specific surface area of no more than 10 m²/g, in a fresh state.

3. The particulate filter according to claim 1, wherein the calcium aluminate has a specific surface area of no more than 10 m²/g, after 4 hr calcination in air at 1000° C.

4. The particulate filter according to claim 1, wherein the calcium aluminate has a D₉₀ of 6 to 400 μm.

5. The particulate filter according to claim 1, wherein the calcium aluminate has a bulk density of 0.2 to 3.0 g/cm³.

6. The particulate filter according to claim 1, wherein the mass ratio of aluminum oxide to calcium oxide is 1.1 to 9.

7. The particulate filter according to claim 1, wherein the calcium aluminate comprises no more than 20% wt of an inorganic impurity, calculated as its oxide.

8. The particulate filter according to claim 7, wherein the inorganic impurity comprises at least one component selected from the group consisting of silicon, titanium, magnesium, iron, copper, zirconium, cerium, and barium.

9. The particulate filter according to claim 1, wherein the functional material layer is coated in a particulate form.

10. The particulate filter according to claim 1, wherein the loading of the functional material layer is between 0.1 and 100 g/L.

11. The particulate filter according to claim 1, wherein the filter further comprises a porous body comprising a plurality of pores, and a catalytic washcoat within at least a portion of the plurality of pores;
wherein the catalytic washcoat comprises one or more components selected from the group consisting of a selective catalytic reduction (SCR) catalyst, a diesel oxidation catalyst (DOC), a three-way conversion (TWC) catalyst, an AMOx catalyst, a NOx trap, a NOx absorber catalyst, and a hydrocarbon trap catalyst; and
wherein the catalytic washcoats are applied to the particulate filter prior to application of the functional material layer.

12. A system for exhaust gas treatment from an internal combustion engine comprising: the particulate filter according to claim 1, and one or more components selected from the group consisting of a selective catalytic reduction (SCR) catalyst, a three way conversion (TWC) catalyst, a diesel oxidation catalyst (DOC), an ammonia oxidation (AMOx) catalyst, a NOx trap, a NOx absorber catalyst, and a hydrocarbon trap catalyst.

13. A method for the treatment of exhaust gas from an internal combustion engine comprising:
(1) providing the particulate filter according to claim 1, and
(2) conducting the exhaust gas from the engine through the particulate filter.

14. The method according to claim 13, wherein the exhaust gas comprises unburnt hydrocarbons, carbon monoxide, nitrogen oxides, and particulate matter.

15. The particulate filter according to claim 1, wherein the calcium aluminate has a D₉₀ of 10 to 200 μm.

16. The particulate filter according to claim 1, wherein the calcium aluminate has a bulk density of 0.3 to 1.8 g/cm³.

17. The particulate filter according to claim 1, wherein the mass ratio of aluminum oxide to calcium oxide is 1.5 to 5 in the calcium aluminate.

18. The particulate filter according to claim 1, wherein the calcium aluminate comprises no more than 15% wt of an inorganic impurity, calculated as its oxide.

19. The particulate filter according to claim 1, wherein the functional material layer is coated in a particulate form via gas phase carrier.

20. The particulate filter according to any claim 1, wherein the loading of the functional material layer is between 1 and 75 g/L.
